(19) United States
(12) Patent Application Publication
(10) Pub. No.: US 2008/0236747 A1
(43) Pub. Date: Oct. 2, 2008

(54) GAS ANALYZING APPARATUS AND SUBSTRATE PROCESSING SYSTEM

(75) Inventors: Tatsuo MATSUDO, Nirasaki-shi (JP); Chishio KOSHIMIZU, Nirasaki-shi (JP); Tomohiro SUZUKI, Nirasaki-shi (JP); Jun Abe, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/057,940

(22) Filed: Mar. 28, 2008

(30) Foreign Application Priority Data
Mar. 30, 2007 (JP) 2007-092192

(51) Int. Cl. G01B 11/02; G01N 25/00; H01J 49/26; C23F 1/00

(52) U.S. Cl. 156/345.24; 73/25.05; 356/503; 250/281

(57) ABSTRACT

A gas analyzing apparatus includes a measurement chamber having a mounting member for mounting thereon a substrate on which a sample is adsorbed; a depressurizing mechanism for depressurizing the inside of the measurement chamber; and a heating unit for heating the substrate having the adsorbed sample thereon and mounted on the mounting member. The apparatus further includes: a mass spectrometer inserted in the measurement chamber, for detecting gas molecules escaping from the sample with an increasing temperature; and a temperature measuring unit for measuring a temperature of the substrate having the adsorbed sample thereon by using an interferometer which detects an optical thickness of the substrate.

### FIELD OF THE INVENTION

The present invention relates to a temperature programmed desorption (TPD) gas analyzing apparatus for detecting gas molecules escaping from a sample with an increasing temperature of a substrate on which the sample is adsorbed; and also relates to a substrate processing system for processing a substrate including a silicon oxide film.

### BACKGROUND OF THE INVENTION

A temperature programmed desorption (TPD) gas analyzing method is an analysis method for detecting gas molecules escaping from a sample when the temperature of the sample is increased and calculating the number of the gas molecules by a function of temperature of the sample. For example, when a thin film, which is a sample, is adsorbed on a Si wafer serving as a substrate, the TPD gas analyzing method is employed to detect a binding energy between the thin film and the Si wafer.

Referring to FIG. 12, there is provided a conventional TPD gas analyzing apparatus. A substrate W having a sample m adsorbed thereon is loaded on a mounting table 51a in a measurement chamber 51. The substrate W on the mounting table 51a is heated by a heating source such as a lamp or the like. With an increase of the temperature of the substrate W on which the sample m is adsorbed, gas molecules escape from the sample m. The escaping gas molecules are analyzed by using a mass spectrometer 52 such as a quadrupole mass spectrometer or the like. The mass spectrometer 52 is a device for counting the number of gas molecules in a vacuum (see, for example, Japanese Patent Laid-open Publication No. 2005-83887).

If a relationship between the temperature of the substrate W having the sample m thereon and the number of the gas molecules generated from the sample m is obtained, it is possible to predict a temperature degree where the binding energy between the sample m and the substrate W would be extinguished. For example, it is possible to detect a temperature level where the binding energy between a Si wafer and a thin film deposited on the Si wafer would be extinguished, resulting in sublimation of the thin film into gas molecules escaping from the Si wafer.

In the conventional gas analyzing apparatus, the temperature of the sample m is indirectly measured by a thermocouple 53 embedded in the mounting table 51a. However, to detect the gas molecules by the mass spectrometer 52, the inside of the measurement chamber 51 is required to be maintained in a high vacuum lest other substances than the gas molecules to be analyzed should be detected. Since a heat transfer between the mounting table 51a and the substrate W is hard to be carried out under the high vacuum condition, the temperature of the substrate W cannot be regulated to the same level as that of the mounting table 51a when a dynamic measurement is performed while increasing the temperature of the substrate W. Besides, in the event that thermal capacitances of the mounting table 51a and the substrate W are different, a temperature variation of the substrate W does not follow a temperature variation of the mounting table 51a. For the reason, when measurements are carried out while varying a temperature rising rate multiple times, the temperature of the sample would become totally different from a measurement value of the thermocouple 53.

That is, though the temperature of the sample m is an important parameter, the conventional gas analyzing apparatus just measures the temperature of the mounting table 51a, not the temperature of the sample m. As mentioned, since the analysis is carried out under the high vacuum condition, the temperature of the mounting table 51 cannot be regarded as the temperature of the sample m due to the poor heat transfer between the mounting table 51a and the substrate W. As a result, stability or reproducibility of available data is degraded.

Meanwhile, as an etching system for etching a silicon oxide (SiO₂) film formed on the substrate W, there is known a system of a type which removes the silicon oxide film by exposing it to a reactant gas without using a plasma. As shown in FIG. 13, an etching system of this type includes a COR (Chemical Oxide Removal) apparatus 56 for reacting the silicon oxide film with a gas containing halogen atoms and a basic gas chemically; and a PHT (Post Heat Treatment) apparatus 57 for removing a reaction product from the Si wafer by heating and vaporizing the reaction product. The gas containing halogen atoms may be, for example, hydrogen fluoride (HF) gas, and the basic gas may be, for example, ammonia (NH₃) gas. If the hydrogen fluoride gas and the ammonia gas are reacted with the silicon oxide (SiO₂), ammonium hexafluorosilicate ((NH₄)₂SiF₆) is generated as a reaction product. After the COR process, a PHT process is conducted to heat the Si wafer on which the reaction product is adsorbed. As a result, the reaction product sublimates from the substrate W, so that the SiO₂ film is etched.

In the conventional etching system, an end of the sublimation of the reaction product, i.e., an end point of the sublimation is determined empirically based on a processing time of the PHT process. However, the method of detecting the end point only from the PHT processing time does not involve detecting the state of the film, so that it cannot be said the end point is recognized accurately.

### SUMMARY OF THE INVENTION

In view of the foregoing, the present invention provides a gas analyzing apparatus capable of measuring a temperature of a sample accurately.

Further, the present invention also provides an etching system capable of detecting, in an etching system which removes a silicon oxide film, an end point accurately by detecting a state of the silicon oxide film.

In accordance with an aspect of the present invention, there is provided a gas analyzing apparatus including: a measurement chamber having a mounting member for mounting thereon a substrate on which a sample is adsorbed; a depressurizing mechanism for depressurizing the inside of the measurement chamber; a heating unit for heating the substrate having the adsorbed sample thereon and mounted on the mounting member; a mass spectrometer inserted in the measurement chamber, for detecting gas molecules escaping from the sample with an increasing temperature; and a temperature measuring unit for measuring a temperature of the substrate having the adsorbed sample thereon by using an interferometer which detects an optical thickness of the substrate.

Preferably, the substrate is a Si wafer, and the sample is a film formed thereon.

The mass spectrometer may be a quadrupole mass spectrometer.

The interferometer may be a low-coherence interferometer using a light source having a low interference property.

The measurement chamber may include a window which transmits light between the outside and the inside of the measurement chamber, and the interferometer may irradiate light to the substrate having the adsorbed sample through the window.

In accordance with another aspect of the present invention, there is provided a substrate processing system including: a chemical reaction processing apparatus for exposing a substrate having a silicon oxide film to a gas containing a halogen gas and a basic gas and reacting the silicon oxide film with the gases chemically, thereby transmuting the silicon oxide film into a reaction product; and a heat treatment apparatus for heating and vaporizing the reaction product, thereby removing the reaction product from the substrate. The heat treatment apparatus includes: a processing chamber having a mounting member for mounting thereon the substrate having the reaction product; a depressurizing mechanism for depressurizing the inside of the processing chamber; a heating unit for heating the substrate on the mounting member; a mass spectrometer inserted in the processing chamber, for detecting gas molecules of the reaction product escaping from the substrate with an increase of temperature; and a temperature measuring unit for measuring a temperature of the substrate by using an interferometer which detects an optical thickness of the substrate.

Preferably, an end point of a heat treatment of the heat treatment apparatus is detected based on detection and measurement results of the mass spectrometer and the temperature measuring unit.

In accordance with the present invention, since a temperature of a sample is same as that of a substrate, an accurate temperature of the sample can be obtained by measuring temperature of the substrate, on which the sample is adsorbed, by using an interferometer. Accordingly, temperature rising rate or peak temperature is obtained, so that right analysis on a sample treatment status can be possible.

Further, it is possible to accurately recognize the end point of the PHT process by detecting the reaction product sublimated while accurately measuring the temperature of the reaction product.

### BRIEF DESCRIPTION OF THE DRAWINGS

The above and other features of the present invention will become apparent from the following description of an embodiment given in conjunction with the accompanying drawings, in which:

FIG. 1 is a schematic configuration view of a gas analyzing apparatus in accordance with an embodiment of the present invention;

FIG. 2 sets forth a schematic diagram showing a heating unit of the gas analyzing apparatus;

FIG. 3 provides an explanatory diagram to describe a principle of a mass spectrometer;

FIG. 4 presents a schematic diagram showing a quadrupole spectrometer unit;

FIG. 5 depicts an explanatory diagram to describe a temperature measuring unit using an optical interferometer;

FIG. 6 offers a diagram showing a relationship between a moving distance of a reference mirror and an interference intensity of light;

FIG. 7 sets forth a graph showing a relationship between a temperature and a refractive index of a Si wafer, a relationship between a temperature and an expansion coefficient of the Si wafer, and a relationship between a temperature and an optical path length of the Si wafer;

FIG. 8 depicts a conceptual diagram showing an etching system in accordance with the embodiment of the present invention;

FIG. 9 is a configuration view of a COR apparatus;

FIG. 10 is a configuration view of a PHT apparatus;

FIG. 11 sets forth a graph providing a comparison of temperature measurement results by a thermocouple and a low-coherence interferometer;

FIG. 12 illustrates a schematic configuration view of a conventional gas analyzing apparatus; and

FIG. 13 presents a diagram to describe a principle of an etching system including conventional COR and PHT apparatuses.

### DETAILED DESCRIPTION OF THE EMBODIMENT

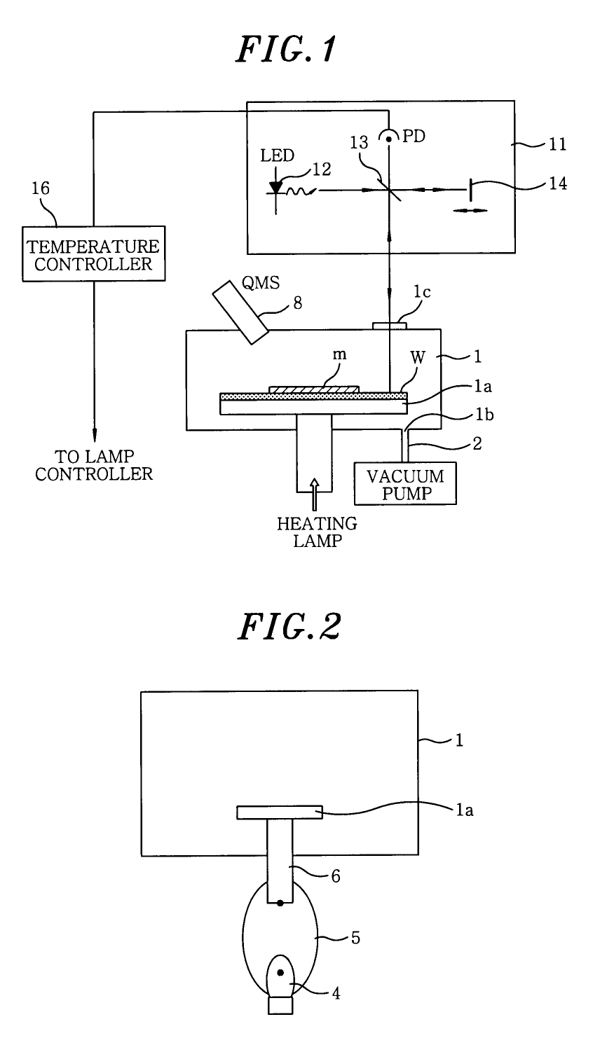

Hereinafter, a gas analyzing apparatus in accordance with an embodiment of the present invention will be described with reference to the accompanying drawings which form a part hereof. FIG. 1 is a schematic configuration view of the gas analyzing apparatus. In FIG. 1, a notation W represents a Si wafer used as a substrate on which a thin film m, which is a sample, is adsorbed. The Si wafer W is loaded on a mounting table 1a in a measurement chamber 1.

A gas exhaust port 1b is provided at a bottom portion of the measurement chamber 1, and a vacuum pump 3 serving as a depressurizing mechanism is connected to the gas exhaust port 1b via a gas exhaust line 2. A gas in the measurement chamber 1 is exhausted by the vacuum pump 3. An inner pressure of the measurement chamber 1 is maintained at a high vacuum level ranging from, e.g., about 10⁻³ Pa.

The measurement chamber 1 is coupled to an evacuable load lock chamber (not shown), and a gate valve is provided between the measurement chamber 1 and the load lock chamber. The Si wafer W is transferred to be mounted on the mounting table 1a inside the measurement chamber 1 via the load lock chamber.

The Si wafer W on the mounting table 1a is heated by infrared rays irradiated from a halogen lamp which is used as a heating unit. FIG. 2 illustrates a schematic configuration view of the heating unit. A halogen lamp 4 is located inside an oval light collector 5 whose inner surface is formed as a mirror. The light collector 5 has two focal points, and the halogen lamp 4 is disposed at one of the focal points. A transparent quartz pillar 6 is inserted in the light collector 5 along a longer axial direction thereof, and one end of the quartz pillar 6 is located at the other focal point of the light collector 5. The infrared rays from the halogen lamp 4 are collected into the quartz pillar 6. The infrared rays that have entered the quartz pillar 6 propagate to the other end of the quartz pillar 6 while being totally reflected in the quartz pillar 6.

As a result, the infrared rays are introduced into the measurement chamber 1, which is kept in a vacuum state, from the light collector 5 which is in a non-vacuum atmosphere. The light that has propagated through the quartz pillar 6 is led to the mounting table 1a disposed on top of the quartz pillar 6. The mounting table 1a is also made of a transparent quartz material. After passing through the mounting table 1a, the infrared rays are irradiated to the Si wafer W mounted on the mounting table 1a. The Si wafer W absorbs the infrared rays, whereby its temperature increases. Alternatively, the halogen lamp 4 may be disposed within the measurement chamber 1 to irradiate the infrared rays from the halogen lamp 4 to the Si wafer W directly.

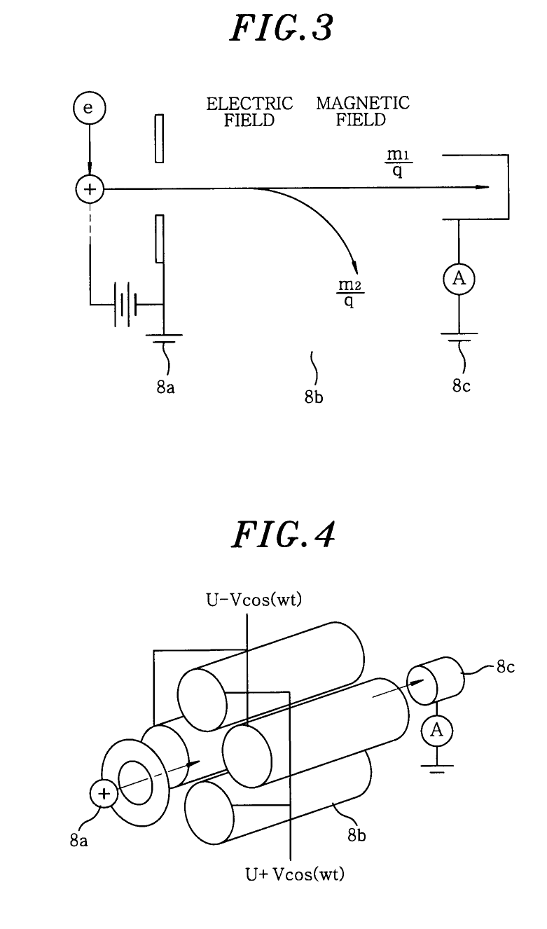

As illustrated in FIG. 1, a mass spectrometer 8 is inserted in the measurement chamber 1. FIG. 3 provides an explanatory diagram to describe a principle of the mass spectrometer 8. The mass spectrometer 8 measures a partial pressure of each gas in a state where two or more gases are mixed. The mass spectrometer 8 includes an ion source 8a, a spectrometer unit 8b and a detecting unit 8c. Gas molecules are ionized by the ion source 8a, and thus generated ions are collected by the detecting unit 8c. The spectrometer unit 8b allows only the ions having a specific mass/charge ratio (m/q) to pass therethrough by using an electric field or a magnetic field.

For example, a nitrogen molecule has a mass (molecular weight) of 28, and a carbon monoxide molecule has a mass (molecular weight) of 28. Since the mass spectrometer 8 can only perform a mass division, it cannot distinguish the nitrogen molecule from the carbon monoxide molecule. However, given that a generated gas molecule is known in advance, it is possible to identify the gas molecule from the mass.

The spectrometer unit 8b is of a quadrupole type. As illustrated in FIG. 4, the quadrupole spectrometer unit 8b has four electrodes to which a DC voltage referred to as U and an AC voltage referred to as ±Vcos (wt) are applied together. The ion source 8a is located at the left side in FIG. 4, and the ions that have passed through a space surrounded by the four electrodes are collected by the detecting unit 8c shown at the right side in FIG. 4. Alternatively, the spectrometer unit 8b may be of a magnetic sector type, an omegatron, or the like, other than the quadrupole type mentioned in this example.

As shown in FIG. 1, provided at a top portion of the measurement chamber 1 is a window 1c through which the Si wafer W in the measurement chamber 1 can be seen from the outside. Further, connected to the window W is a temperature measuring unit 11 and 16 for measuring the temperature of the Si wafer by using a low-coherence interferometer for detecting an optical path length (optical thickness) of the Si wafer W.

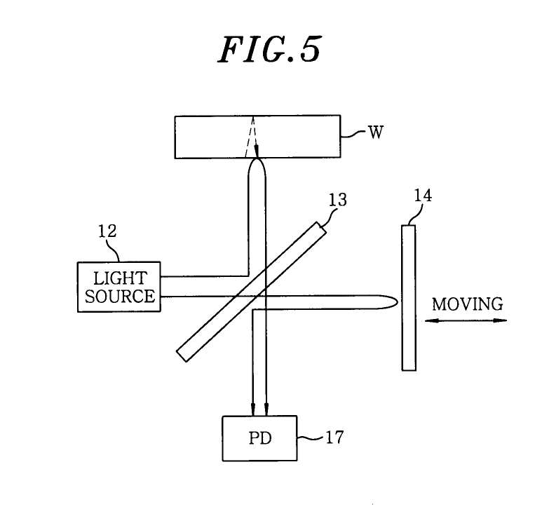

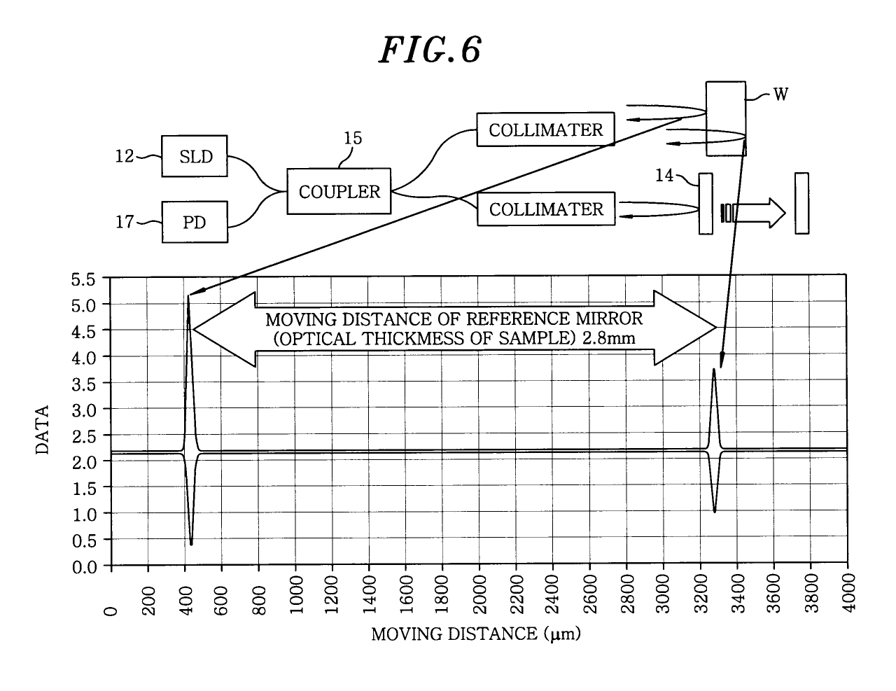

FIG. 5 presents an explanatory diagram to describe a principle of the temperature measuring unit using the interferometer. In FIG. 5, positions of the Si wafer W and a photodiode (PD) are shown reversed for the convenience sake. As a light source 12, an SLD (Super Luminescent Diode) having a low interference property is used. Here, it may be also possible to use a halogen lamp, natural light, an LED, an ASE (Amplified Spontaneous Emission) source, a SC (Super Continuum) source or the like, instead of the SLD. Light from the light source 12 is irradiated to a half mirror 13. The half mirror 13 divides the light from the light source 12 into reference light incident upon a reference mirror 14 and measurement light incident upon the Si wafer W. In lieu of the half mirror 13, an optical fiber coupler 15 (see FIG. 6) can be used.

The reference mirror 14 can be moved along the direction of the reference light to vary the optical path length of the reference light. The reference mirror 14 is moved by a motor such as a stepping motor or the like. The moving amount and speed of the reference mirror 14 is controlled by a motor controller. The moving amount of the reference mirror is measured by a laser interferometer or the like. The moving amount data of the reference mirror 14 obtained by the laser interferometer is sent to the temperature controller 16 (see FIG. 1) such as a computer or the like.

When a temperature measurement is carried out, a strong interference takes place when an optical path length of reflection light by the top surface of the Si wafer W coincides with an optical path length of reflection light by the reference mirror 14 while the reflection mirror 14 is being moved. The PD 17 serving as a light receiving device measures such interference of light and sends the measurement data to the temperature controller 16. Further, while the reflection mirror 14 is being moved, a strong interference also occurs when an optical path length of reflection light by the bottom surface of the Si wafer W coincides with the optical path length of the reflection light by the reference mirror 14.

FIG. 6 illustrates a relationship between a moving distance of the reflection mirror 14 and an interference intensity of light. From the figure, two strong interferences are observed for the top surface side and the bottom surface side of the Si wafer W, respectively. A moving distance (2.8 mm in this example) of the reflection mirror 14 from a point of occurrence of the first interference to a point of occurrence of the second interference is the optical path length (optical thickness) of the Si wafer W.

As can be seen from FIG. 7, temperature and refractive index of the Si wafer W are in a proportional relationship, and so are temperature and thermal expansion rate of the Si wafer W. Since an optical path length is given by a multiplication of a thickness and a refractive index (i.e., optical path length=thickness×refractive index), temperature and optical path length also have a proportional relationship. As for the Si wafer W, its optical path length varies at a rate of about 0.2 μm/° C. When temperature changes, the optical path length also varies, resulting in a variation of peak positions of interference waveforms. By detecting a deviation of the peak positions of the interference waveforms, the temperature of the Si wafer w can be obtained.

Further, since the thin film m is adsorbed on the Si wafer W, the temperature of the thin film m is identical with the temperature of the Si wafer W. Thus, by detecting the temperature of the Si wafer W, the temperature of the thin film m can be obtained. Alternatively, since the optical path length of the thin film m can be measured, the temperature of the thin film m can be detected based on the optical path length thereof.

Now, a gas analyzing method, which is performed by using the above-described gas analyzing apparatus, will be explained. First, after the Si wafer W is loaded on a transfer arm of a load lock chamber, the load lock chamber is evacuated, so that the inside of the load lock chamber is set to a high vacuum state. In this state, a gate valve between the load lock chamber and the measurement chamber 1 is opened, and by moving the transfer arm, the Si wafer W is conveyed to be mounted on the mounting table 1a in the measurement chamber 1.

When heating the Si wafer W on which the sample m is adsorbed, gas molecules of the thin film m escape from the Si wafer W with an increasing temperature. The gas molecules are detected by the mass spectrometer 8 inserted in the measurement chamber 1. The temperature of the thin film m is directly measured by the temperature measuring unit. Thus, it is possible to accurately calculate the number of the gas molecules escaping from the thin film m as a function of the temperature of thin film m with the temperature increase thereof. After completing the measurement, the Si wafer W is unloaded from the measurement chamber 1 in the reverse sequence as described above.

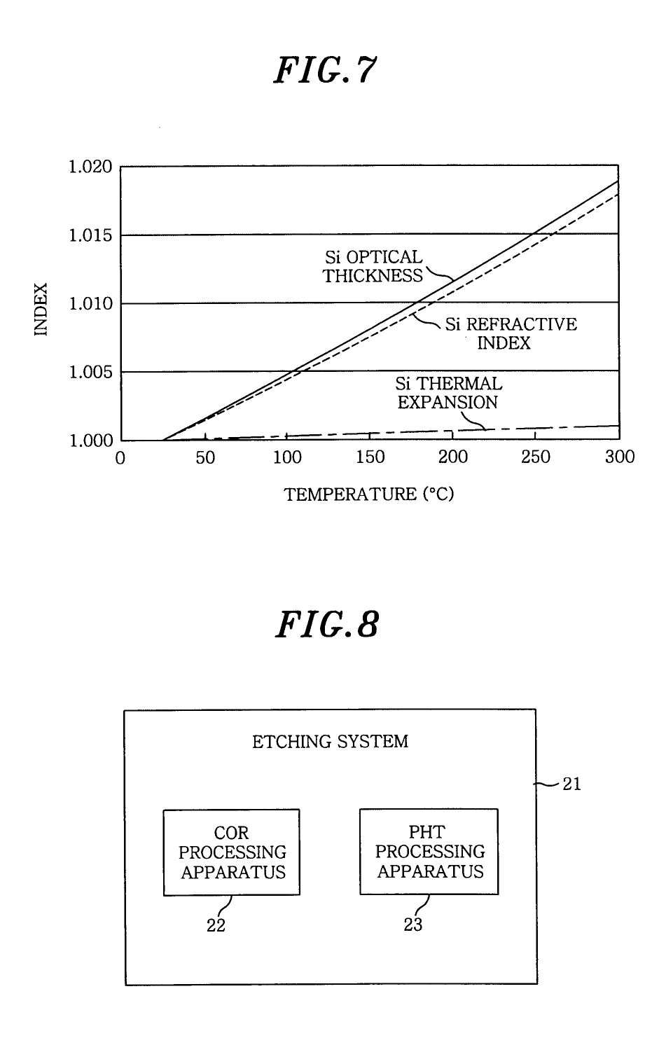

FIG. 8 illustrates an etching system 21 in accordance with the embodiment of the present invention. The etching system 21 etches a Si wafer having a silicon oxide film. The silicon oxide film may be a natural oxide film. The etching system 21 includes a COR apparatus (chemical reaction processing apparatus) 22 for transmuting the silicon oxide film into a reaction product by exposing the silicon oxide film to a gas containing halogen atoms and a basic gas to thereby allow the silicon oxide film to react with those gases; and a PHT apparatus (heat treatment apparatus) 23 for removing the reaction product from the substrate by heating it.

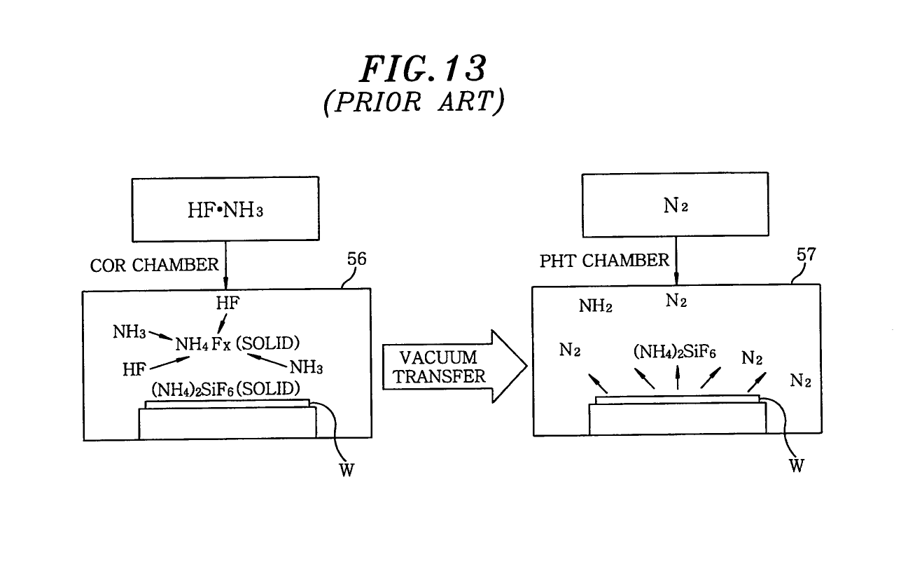

The gas containing halogen atoms used in the COR apparatus 22 is, for example, a hydrogen fluoride (HF) gas, and the basic gas is, for example, ammonia (NH₃) gas (see FIG. 13). From the hydrogen fluoride (HF) gas and the ammonia (NH₃) gas, solid NH₄Fₓ is generated. When the NH₄Fₓ reacts with the silicon oxide (SiO₂), ammonium hexafluorosilicate ((NH₄)₂SiF₆) is generated as a reaction product, as can be seen from a reaction formula of NH₄Fₓ+SiO₂ (NH₄)₂SiF₆. Thereafter, if the Si wafer is heated in a PHT process, the reaction product sublimates from the Si wafer, accomplishing the etching of the silicon oxide film on the Si wafer resultantly.

The PHT apparatus 23 is connected to the COR apparatus 22 by being coupled to a common transfer chamber which is vacuum-evacuable. The PHT apparatus 23 is disposed between the COR apparatus 22 and the common transfer chamber. Further, respective gate valves are provided between the PHT apparatus and the common transfer chamber and between the COR apparatus and the common transfer chamber. The common transfer chamber is equipped with a transfer arm.

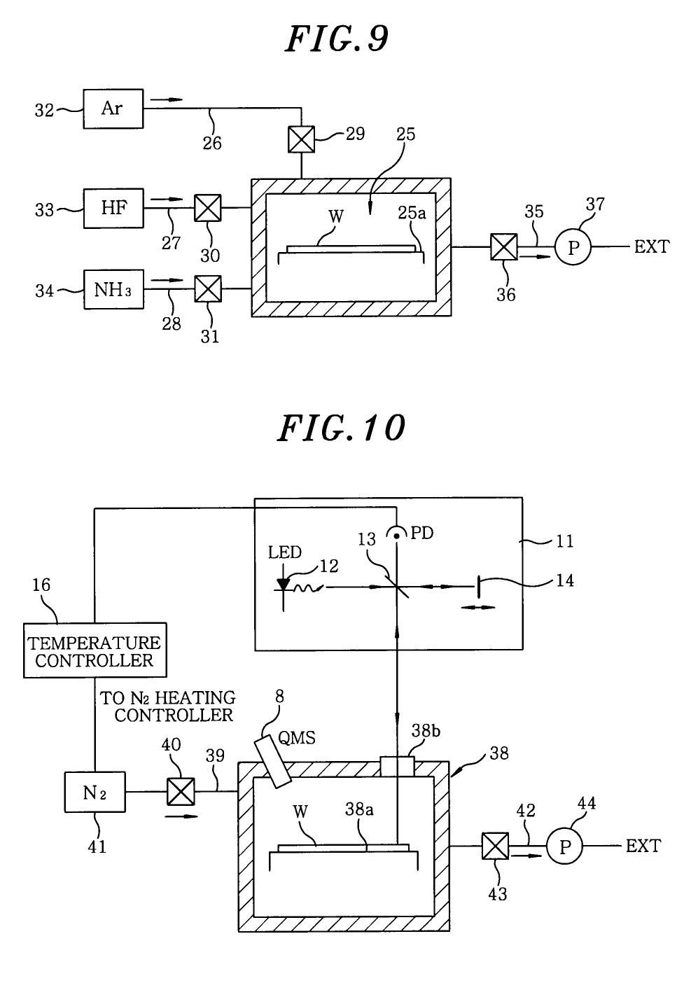

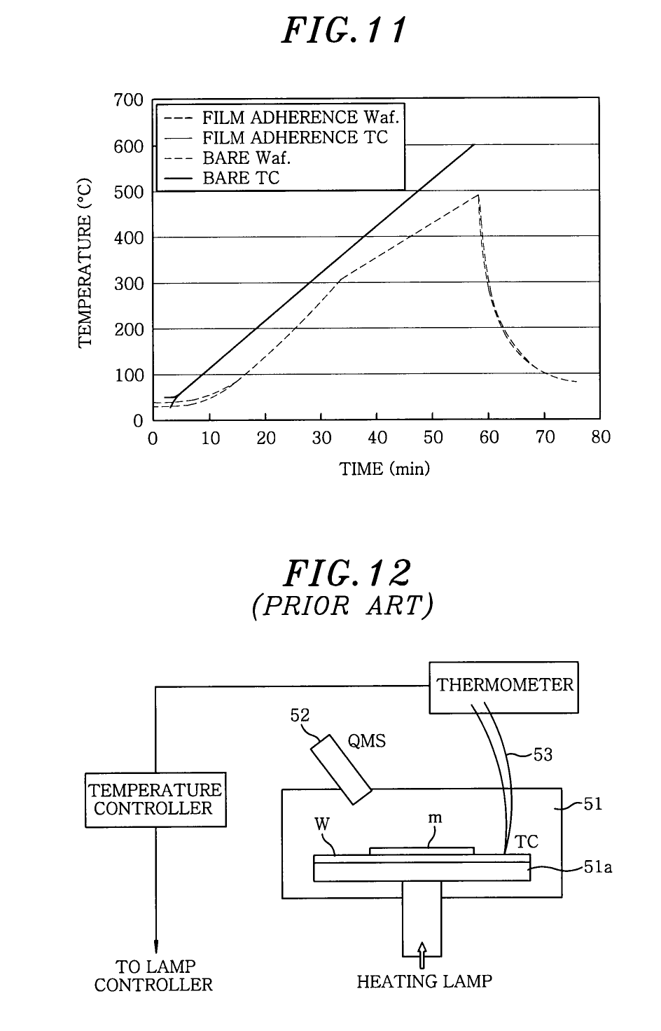

FIG. 9 illustrates the COR apparatus 22. The Si wafer W is accommodated in a processing chamber 25. Inside the processing chamber 25, there is provided a mounting table 25a for mounting the Si wafer W thereon in a substantially horizontal state. The mounting table 25a has a temperature control mechanism for controlling the temperature of the Si wafer W. Provided in a sidewall of the processing chamber 25 is a loading/unloading port through which the Si wafer W is loaded into or unloaded from the processing chamber 25, and a gate valve is provided at the loading/unloading port.

Connected to the processing chamber 25 are a supply line 27 for supplying the hydrogen fluoride (HF) gas, a supply line 28 for supplying the ammonia (NH₃) gas, and a supply line for supplying an inert gas such as argon (Ar) gas or the like as a dilution gas. Flow rate controlling valves 29 to 31 are provided on the supply lines 26 to 28, respectively. One ends of the supply lines 26 to 28 are connected to an argon gas supply source 32, an ammonia gas supply source 34 and a hydrogen fluoride gas supply source 33, respectively. The hydrogen fluoride gas, the ammonia gas and the argon gas are introduced into the processing chamber 25 from a shower head (not shown) disposed at a top portion of the processing chamber 25. Further, a gas exhaust line 35 for exhausting the processing chamber 25 is connected to the processing chamber 25, and an opening/closing valve 36 and a vacuum pump 37 for depressurizing the inside of the processing chamber 35 are installed in the gas exhaust line 35.

FIG. 10 shows the PHT apparatus 23. The Si wafer W is loaded on a mounting table 38a within a processing chamber 38. The processing chamber 38 is provided with a loading/unloading port through which the Si wafer W is loaded into or unloaded from the processing chamber 38.

Also connected to the processing chamber 38 is a supply line 39 for supplying a nonreactive gas such as a nitrogen gas (N₂) gas or the like into the processing chamber 38 while heating, as a heating unit, the nonreactive gas. The supply line 39 is coupled to a nitrogen gas supply source 41 via a flow rate controlling valve 40. Further, a gas exhaust line 42 for exhausting the processing chamber 38 is connected to the processing chamber 38, and an opening/closing valve 43 and a vacuum pump 44 for depressurizing the inside of the processing chamber 38 are installed in the gas exhaust line 42.

A mass spectrometer 8 for detecting gas molecules of a reaction product is inserted in the processing chamber 38. Since the principle and structure of the mass spectrometer 8 are the same as those of the mass spectrometer 8 of the aforementioned gas analyzing apparatus in accordance with the embodiment of the present invention, the like reference numeral is assigned, and description thereof will be omitted.

The processing chamber 38 is provided with a window 38b, and a temperature measuring unit 11 and 16 for measuring the temperature of the Si wafer W is connected to the window 38b. Since the principle and structure of the temperature measuring unit is identical with that of the gas analyzing apparatus, like reference numerals are assigned to the like parts, and their description will be omitted.

Now, a processing method for the Si wafer W which is performed by the etching system will be explained. The Si wafer W conveyed into the common transfer chamber is loaded into the processing chamber 25 of the COR apparatus 22. The Si wafer W is maintained on the mounting table 25a in the processing chamber 25 such that the silicon oxide film is positioned uppermost.

After the Si wafer W is loaded into the processing chamber 25, the gate valve is closed, and a COR process is begun. In the COR process, the processing chamber 25 is depressurized to a pressure level lower than an atmospheric pressure, e.g., less than 1 Torr. For example, when the hydrogen fluoride gas and the ammonia gas are supplied into the processing chamber 25 under the processing conditions in which the temperature of the processing chamber ranges from 10° C. to 30° C. and the pressure thereof is less than 1 Torr, the silicon oxide film on the Si wafer W is transmuted into a reaction product made up of ammonium hexafluorosilicate (NH₄)₂SiF₆).

After the completion of the COR process, the supply of the hydrogen fluoride and the ammonia gas from the respective supply lines is stopped. Then, argon gas is supplied from its corresponding supply line, so that the inside of the processing chamber is purged by the argon gas. Thereafter, the loading/unloading port of the COR apparatus 22 is opened, and the Si wafer W is unloaded from the processing chamber 25 and then loaded into the PHT apparatus 23 by the transfer arm.

In the PHT apparatus 23, the Si wafer W having the reaction product thereon is maintained on the mounting table within the processing chamber 38. After the loading of the Si wafer W is completed, the gate valve is closed, and a PHT process is initiated. In the PHT process, the inside of the processing chamber 38 is evacuated by the vacuum pump 44, while a high-temperature heating gas is supplied from the supply line 39 into the processing chamber 38. For example, if the Si wafer W is heated under the processing conditions in which the temperature of the processing chamber ranges from 100° C. to 200° C. and the pressure thereof is less than 1 Torr, the reaction product on the Si wafer W sublimates, whereby the silicon oxide film is etched consequently.

The temperature measuring unit measures the temperature of the Si wafer W during the PHT process (the temperature of the Si wafer W is identical with the temperature of the reaction product). The mass spectrometer 8 measures the number of gas molecules of the reaction product. Thus, since the gasification of the reaction product can be observed while measuring the temperature of the reaction product accurately, it is possible to detect an end portion of the PHT process exactly. Further, by measuring the Si wafer W being under the PHT process, it is also possible to control the temperature of the Si wafer W lest that the temperature should rise over a necessary level.

Thereafter, the Si wafer W is taken out from the PHT apparatus 23 and conveyed into the common transfer chamber by the transfer arm.

### EXAMPLE

FIG. 11 shows a result of comparing temperature rising rates in individual cases of measuring, in the gas analyzing apparatus shown in FIG. 1, the temperature of the mounting table 1a by means of the thermocouple and measuring the temperature of the Si wafer W directly by means of the temperature measuring unit 11 and 16 using the low-coherence interferometer. In FIG. 11, “TC” represents a result of measuring the temperature of the mounting table 1a by the thermocouple, while “Waf.” represents a result of measuring the temperature of the Si wafer W directly by the temperature measuring unit 11 and 16. Further, “bare” represents a Si wafer W on which no thin film m is attached, while “film adherence” represents a Si wafer W on which a thin film m is adsorbed.

As can be seen from FIG. 11, though it is thought that the temperature measured by means of the thermocouple linearly increases, the actual temperature of the Si wafer W has a point of inflection, so that its temperature rising rate varies nonlinearly. As for a temperature during the temperature increasing operation, there is generated a maximum difference of 100° C. between the temperature of the mounting table 1a measured by the thermocouple and the actual temperature of the Si wafer W. To elaborate, when the temperature measured by the thermocouple reaches 600° C., the temperature of the Si wafer W measured by the temperature measuring unit 11 and 16 is about 480° C., so that there is found a temperature discrepancy of more than 100° C. therebetween.

As a result, since an error in temperature rising rate or peak temperature is made, it has been found that an accurate result cannot be achieved with the temperature programmed desorption gas analyzing apparatus using the thermocouple. In contrast, by measuring the temperature of the Si wafer W directly by means of the temperature measuring unit 11 and 16 using the low-coherence interferometer in accordance with the embodiment of the present invention, measurement accuracy can be improved greatly.

Here, it is to be noted that the present invention can be modified in various ways without being limited to the embodiment described above. For example, a quartz wafer may be used instead of the Si wafer either in the gas analyzing apparatus or the etching system.

Furthermore, as for the gas analyzing apparatus, the heating unit for heating the substrate can be implemented by ejecting a heated gas toward the Si wafer to increase the temperature thereof.

Further, in the PHT apparatus 23, the heating unit for heating the substrate may be implemented by a lamp which heats the mounting table 38a with infrared rays. In the PHT apparatus 23, it is also possible to detect the end point of the PHT process only from the measurement data of the mass spectrometer without having to use the temperature data of the Si wafer W obtained by the temperature measuring unit. Moreover, the temperature data detected by the temperature measuring unit can be used as feedback signals for controlling the heating unit and hence the temperature of the Si wafer.

While the invention has been shown and described with respect to the embodiment, it will be understood by those skilled in the art that various changes and modifications may be made without departing from the scope of the invention as defined in the following claims.

What is claimed is:

1. A gas analyzing apparatus comprising:
a measurement chamber having a mounting member for mounting thereon a substrate on which a sample is adsorbed;
a depressurizing mechanism for depressurizing the inside of the measurement chamber;
a heating unit for heating the substrate having the adsorbed sample thereon and mounted on the mounting member;
a mass spectrometer inserted in the measurement chamber, for detecting gas molecules escaping from the sample with an increasing temperature; and
a temperature measuring unit for measuring a temperature of the substrate having the adsorbed sample thereon by using an interferometer which detects an optical thickness of the substrate.

2. The gas analyzing apparatus of claim 1, wherein the substrate is a Si wafer, and the sample is a film formed thereon.

3. The gas analyzing apparatus of claim 1, wherein the mass spectrometer is a quadrupole mass spectrometer.

4. The gas analyzing apparatus of claim 1, wherein the interferometer is a low-coherence interferometer using a light source having a low interference property.

5. The gas analyzing apparatus of claim 1, wherein the measurement chamber comprises a window which transmits light between the outside and the inside of the measurement chamber, and the interferometer irradiates light to the substrate having the adsorbed sample through the window.

6. A substrate processing system comprising:
a chemical reaction processing apparatus for exposing a substrate having a silicon oxide film to a gas containing a halogen gas and a basic gas and reacting the silicon oxide film with the gases chemically, thereby transmuting the silicon oxide film into a reaction product; and
a heat treatment apparatus for heating and vaporizing the reaction product, thereby removing the reaction product from the substrate,
wherein the heat treatment apparatus comprises:
a processing chamber having a mounting member for mounting thereon the substrate having the reaction product;
a depressurizing mechanism for depressurizing the inside of the processing chamber;
a heating unit for heating the substrate on the mounting member;
a mass spectrometer inserted in the processing chamber, for detecting gas molecules of the reaction product escaping from the substrate with an increase of temperature; and
a temperature measuring unit for measuring a temperature of the substrate by using an interferometer which detects an optical thickness of the substrate.

7. The substrate processing system of claim 6, wherein an end point of a heat treatment of the heat treatment apparatus is detected based on detection and measurement results of the mass spectrometer and the temperature measuring unit.
